(19) United States
(12) Patent Application Publication
(10) Pub. No.: US 2012/0171987 A1
(43) Pub. Date: Jul. 5, 2012

(54) SMOKE OR FIRE ALARMS

(76) Inventor: Matthew James Newman, Herfordshire (GB)

(21) Appl. No.: 13/382,133

(22) PCT Filed: Apr. 21, 2010
(86) PCT No.: PCT/GB10/00795

§ 371 Date: Mar. 15, 2012

(30) Foreign Application Priority Data
Jul. 1, 2009 (GB) 0911412.5

(51) Int. Cl. H04W 4/22; G08B 17/10

(52) U.S. Cl. 455/404.1; 340/628

(57) ABSTRACT

The present invention provides a battery-powered smoke/fire alarm unit which comprises a housing accommodating: at least a first battery; a smoke/fire detector linked to an audible alarm powered by the first battery; a telecommunications unit; and a switch responsive to triggering of the alarm to then connect the telecommunications unit to the first battery or to a second battery in the housing to thence power the telecommunications unit to send a warning message.

### FIELD OF THE INVENTION

The present invention concerns improvements in and relating to smoke alarms or the like and in particular concerns such alarms that are adapted for remote communication via GSM or other telecommunication system to alert of a fire hazard.

### BACKGROUND TO THE INVENTION

Conventional smoke/fire alarms generally comprise a smoke and/or heat detector linked by wire to an audible alarm signal generator to emit a loud alarm signal on the detection of smoke or excessive heat and thereby alert occupants of a building to make their escape. Popular modern smoke alarms generally comprise self-contained compact battery-powered units that are easily installed by the householder and which generally have a 9V battery or multiple AA battery cells that may be replaced or re-charged at intervals.

The problem with a standard battery-powered smoke alarm is that the audible alarm is only of use if the alarm is within hearing distance. For many home-owners it would be very useful for them to be alerted to a fire in their home even if they were not at home or were otherwise in a position where they could not hear the fire alarm. Since a large proportion of fires are slow starting, caused by electrical appliances such as hair straighteners and electric irons left on through an oversight on the part of the home-owner/resident, if the home-owner/resident was made aware of the smoke detection while still being relatively near home, they could potentially take actions themselves to control the spread of fire.

Relatively recently patent proposals have been made to partner a smoke alarm unit with a GSM module in a compact housing, where the system is configured to send out an alarm signal to the emergency services when fire is detected. Such a system is described in GB 2,380,041 which powers the GSM module and the alarm unit's smoke detector continuously through the unit's battery. This system is, however, relatively unviable due to its high current drain/low battery life and since it necessitates the use of costly dedicated airtime contracts.

A number of battery and mains powered smoke alarms linked to external GSM units are commercially available. These usually come as part of a home security pack/set. These have a number of inherent problems, including that: a) should the electricity be cut off during the first stages of an electrical fire (e.g. electrical fire in the fuse box), unless the GSM unit has an additional battery back up the GSM unit will be rendered useless; b) if the GSM unit is unplugged accidentally, the battery backup (assuming one is in place) will only be active until battery life is reached; and c) assuming a battery backup were in place, due to it being a constant feed battery the GSM unit would only be effectual for the duration of the battery life.

### SUMMARY OF THE INVENTION

According to a first aspect of the present invention there is provided a battery-powered smoke/fire alarm unit which comprises a housing accommodating: at least a first battery; a smoke/fire detector linked to an audible alarm powered by the first battery; a telecommunications unit; and a switch responsive to triggering of the alarm to then connect the telecommunications unit to the first battery or to a second battery in the housing to thence power the telecommunications unit to send a warning message.

Preferably the telecommunications unit is a GSM unit and preferably it is configured to send an SMS text warning message warning of the detected smoke/fire via a mobile phone network to the mobile phone of a home-owner, tenant or other interested party. The message might however be a synthesised or pre-recorded audible voice message or an audible tone or indeed transmission of the sound from the audible alarm or might be a code that is recognised by the recipient and/or which generates an audible warning signal at the recipient's device/mobile phone.

Preferably the switch comprises a microphone that is responsive to the sound of the audible smoke/fire alarm operating. Alternatively the switch may be electrically connected to the smoke/fire detector, to the audible alarm or to the connection between them so as to be directly or indirectly electrically triggered by the detection signal from the smoke/fire detector.

Preferably the smoke/fire alarm unit and the telecommunications unit are both powered solely by the first battery and preferably that battery is a Lithium ion battery.

According to a second aspect of the present invention there is provided a battery-powered alarm unit which comprises a housing accommodating: at least a first battery; a hazard (eg fire or flood) or intruder detector linked to an audible alarm powered by the first battery; a telecommunications unit; and a switch responsive to triggering of the alarm to then connect the telecommunications unit to the first battery or to a second battery in the housing to thence power the telecommunications unit to send a warning message, the switch comprising a microphone that is responsive to the sound of the audible alarm operating.

According to a third aspect of the present invention there is provided a component of the battery-powered alarm unit of the first or second aspect and which comprises a said telecommunications unit and a said switch responsive to triggering of the alarm to then connect the telecommunications unit to the first or a second battery of the alarm unit in the housing to thence power the telecommunications unit to send a warning message, the switch comprising a microphone that is responsive to the sound of the audible alarm operating. This component is suitably supplied on a circuit board to be inserted into the alarm unit. This could be sold as an up-grade kit to an existing alarm unit.

According to a fourth aspect of the present invention there is provided a battery-powered smoke/fire alarm unit which comprises a housing accommodating: at least a first battery; a smoke/fire detector linked to an audible alarm powered by the first battery; a telecommunications unit; and a switch responsive to triggering of the alarm to then connect the telecommunications unit to the first battery or to a second battery in the housing to thence power the telecommunications unit to send a warning message wherein the unit is adapted to be programmed by the user with phone numbers to be contacted by the unit, by using the smoke/fire detector's TEST button to initiate programming.

According to a fifth aspect of the present invention there is provided a battery-powered smoke/fire alarm unit which comprises a housing accommodating: at least a first battery; a smoke/fire detector linked to an audible alarm powered by the first battery; a telecommunications unit; and a switch responsive to triggering of the alarm to then connect the telecommunications unit to the first battery or to a second battery in the housing to thence power the telecommunications unit to send a warning message wherein the smoke/fire detector is of a type that is adapted to be networked and the electrical coupling that is provided on the smoke/fire detector for powering and linking individual smoke/fire detectors together in a network is used to electrically connect the circuitry of the telecommunications unit thereto.

According to a sixth aspect of the present invention there is provided a battery-powered smoke/fire alarm unit which comprises a housing accommodating: at least a first battery; a smoke/fire detector linked to an audible alarm powered by the first battery; a telecommunications unit; and a switch responsive to triggering of the alarm to then connect the telecommunications unit to the first battery or to a second battery in the housing to thence power the telecommunications unit to send a warning message wherein the unit comprises a connecting cable between the alarm circuit and the telecommunications unit, the cable having a plug that push-fit couples into a socket containing a ‘live’/power pin and/or an inter-connect pin

### BRIEF DESCRIPTION OF THE DRAWINGS

Preferred embodiments of the present invention will now be more particularly described, by way of example only, with reference to the accompanying drawings, in which:

FIG. 1 is a schematic diagram of a first preferred embodiment of the invention;

FIG. 2 is a schematic diagram of a second preferred embodiment of the invention;

FIGS. 3 to 7 are views of a detailed preferred embodiment based on the schematic layout of the FIG. 1 embodiment,

FIGS. 3A and 3B comprise, respectively, a perspective view of a smoke/fire alarm unit from the main alarm housing part front/outer face (usually the visible lower exterior face in use when the unit is installed to a ceiling) and a perspective view of the same smoke/fire alarm unit from the rear face showing the mounting pattress part (the side that mounts to the ceiling);

FIG. 3C comprises a plan view of the inner face of the main alarm housing part;

FIG. 4 is a disassembled view from the rear of the smoke/fire alarm unit and showing the mounting pattress, main alarm housing part and an intermediate housing plate side by side;

FIG. 5 is a modified schematic diagram of this detailed preferred embodiment;

FIG. 6 is a plan view, corresponding to FIG. 3, of the inner face of the main alarm housing part but with cover removed to show the smoke sensor chamber, the siren and the battery; and

FIG. 7 is a close-up plan view of the underside of the PCB of the main alarm housing part.

### DESCRIPTION OF THE PREFERRED EMBODIMENT

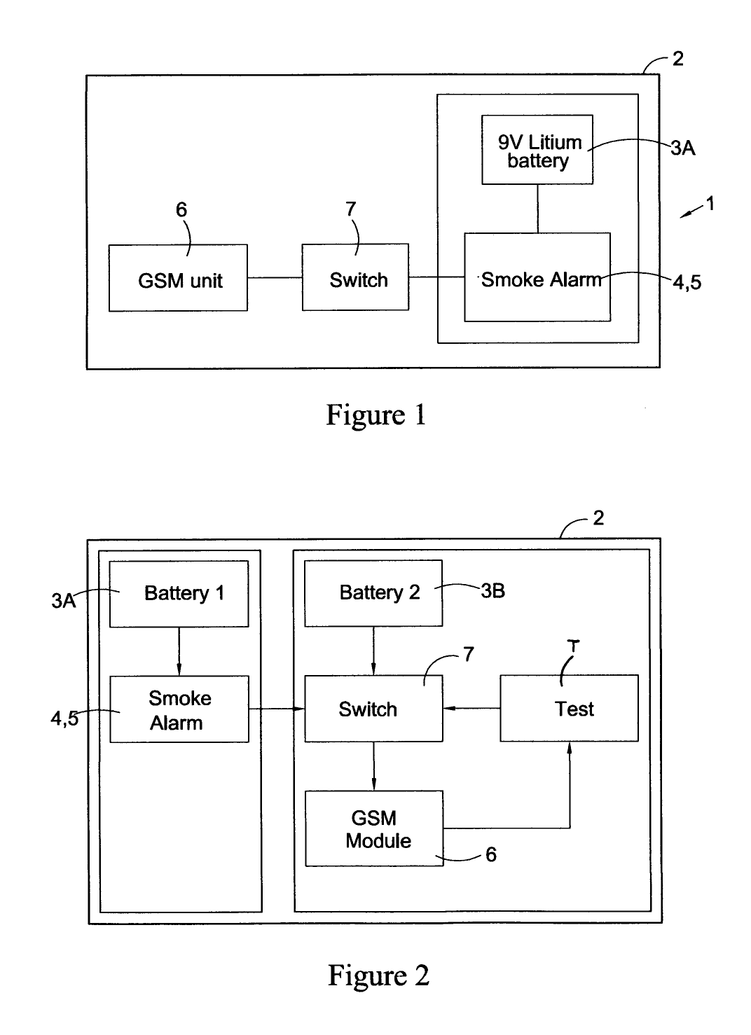

Referring to FIG. 1, this shows a first preferred embodiment of the invention, comprising a battery-powered smoke/fire alarm unit 1. This is a stand-alone unit having a rugged plastics or metal housing 2 that accommodates a first battery 3A and a smoke/fire detector 4 linked to an audible alarm 5 (acoustic signal generator and speaker/horn—ie siren) powered by the first battery 3A.

The housing 2 also accommodates a GSM telecommunication unit 6 and a switch 7 responsive to triggering of the alarm 5 to then connect the telecommunications unit 6 to the first battery 3A in the housing 2 to thence power the telecommunications unit 6 to send a warning message to one or more pre-set/designated numbers.

The smoke alarm unit 1 is thus configured so that it will not only emit an audible alarm that may be heard in the vicinity, but will also transmit an SMS message to one or more pre-set mobile phone numbers alerting to the detection of smoke/fire.

The telecommunications unit 6 is a GSM unit configured to send an SMS text warning message warning of the detected smoke/fire via a mobile phone network to the mobile phone of the home-owner, tenant or other interested party. The switch 7 is electrically connected to the smoke/fire detector 4 or to the audible alarm 5 or to the connection between them so as to be directly or indirectly electrically triggered by the detection signal from the smoke/fire detector 4. The smoke/fire alarm unit's sensor 4 and alarm 5 and the telecommunications unit 6 are all powered solely by the first battery 3A, which is suitably a 9V Lithium ion battery.

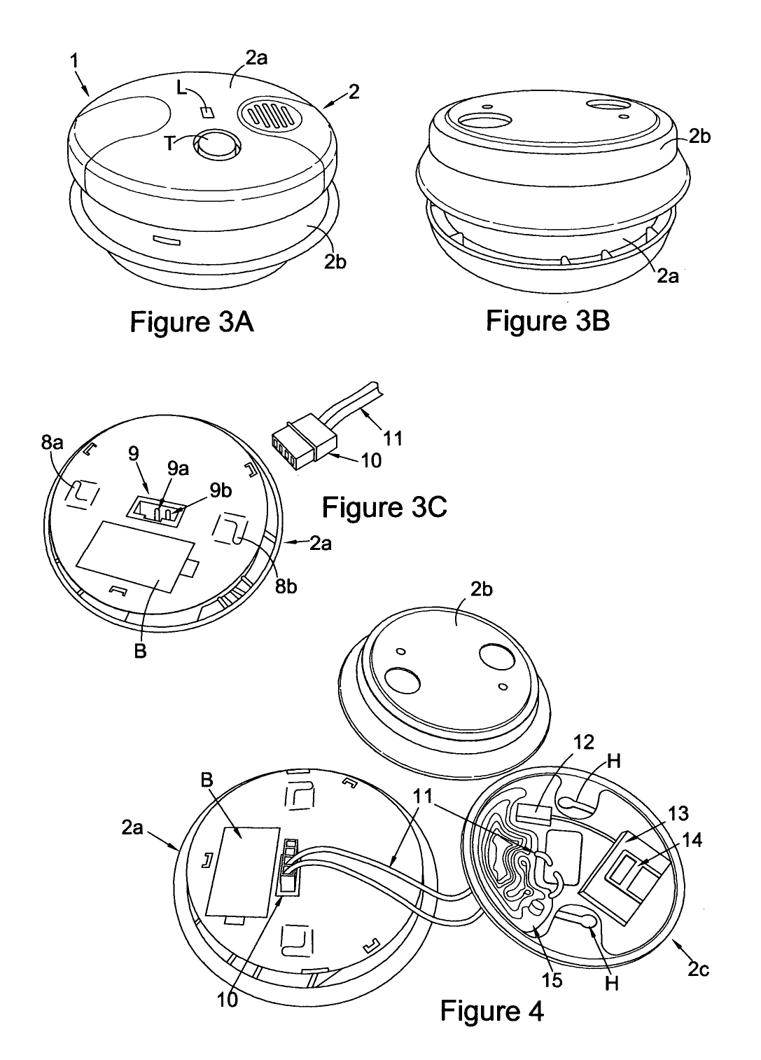

The GSM telecommunication unit 6 is effectively a sleeper unit that is only powered when the smoke detector goes into alarm. When interlink pin (see FIGS. 3 to 7) goes to live the switch 7 then supplies 1 Amp of current from the battery 3A to the GSM telecommunication unit 6 suitably for a limited duration, such as 60 seconds to 2 minutes, sufficient for the GSM telecommunication unit 6 to power up and successfully transmit its SMS message to the one or more target phone numbers. In alternative to being for a set time, the unit may be powered down on receipt of a received signal from the message recipient/mobile phone. The system may be programmed by the user, using the smoke detector's TEST button following a protocol such as:
The TEST button is pressed making the interlink pin live and thereby powering up the GSM telecommunication unit 6. Once powered up the user will send a text message (from a phone that is to be used for receiving alert messages) to the allocated number of the GSM telecommunication unit 6 which will receive the message and store the number in its memory. When the test button is pressed for configuring the system the GSM unit 6 will automatically send a warning message to all phone numbers stored in its memory (ie every time the GSM unit 6 powers up it will transmit an SMS to the stored number(s).

In a variant of this embodiment, instead of the switch 7 being electrically connected to the smoke/fire detector 4 or to the audible alarm 5 or to the connection between them, the switch 7 is linked to a microphone that is arranged to respond to sounding off of the audible alarm 5 to switch the GSM telecommunications unit 6 to be powered from the battery 3A.

Referring to FIG. 2 this shows a second preferred embodiment of the invention that differs from the first by having a dedicated second battery 3B to power the GSM telecommunication unit 6. The dedicated battery 3B is linked to the smoke alarm 4, 5 through the switch 7. Upon receiving a signal from the smoke alarm the switch 7 will “power-up” the GSM telecommunications unit 6. Once fully powered up, the GSM unit 6 will transmit the SMS/text message to the pre-set number alerting the receiver to the smoke detection. Once the SMS has been successfully sent, the GSM unit 6 can be arranged to ‘inform’/switch over the switch 7 to thereby “power-down” the telecommunications unit 6, thereby further preserving the battery life.

As will be appreciated, since the GSM telecommunication unit 6 is linked to a battery 3A, 3B through the switch 7 so that it is only powered upon the switch 7 receiving a smoke detection signal from the smoke alarm unit, the GSM unit 6 only uses the battery 3A, 3B when there is an emergency, thereby conserving battery power. Since both the GSM unit 6 and the smoke alarm unit 4, 5 are located in a common housing structure, there are no exposed wires to be dislodged/disconnected or burnt through.

The GSM unit 6 can be arranged to accept any standard GSM SIM card but suitably has a lower operating cost Machine to Machine SIM card. The GSM unit 6 is suitably configured to be set up by the following protocol:
1) Press the “TEST” button (or another configuration initiating button) on the unit for say 2 seconds. Send a suitable desired alert message to the unit (e.g. “Smoke in the living room”) suitably from the mobile phone that wishes to receive the alerting text message and suitably at least so that the unit is notified of the message to be used and phone number to be sent to.
2) If the user wishes to delete a number, then a blank SMS may be sent from the number wishing to be deleted.

More than 1 phone number may be added to the memory of the GSM unit 6, dependent on free memory space.

A micro-processor of the device may be taught to recognise the sound of the alarm's siren by, for example, pressing a ‘learn’ button linked to the device to put the microprocessor into learning mode. By then pressing the alarm's test button to sound the alarm the sound of the siren may be detected, registered and its pattern, volume and/or other signature stored in the microprocessor's memory and the unit then powered down.

Referring to FIGS. 3 to 7, these illustrate a further, more detailed embodiment of the invention and which is based on an off-the-shelf ceiling mounting smoke sensor of the type that has multiple such units wired together as a system. Each unit has a main alarm housing part 2a and a mounting pattress 2b. The main alarm housing part 2a accommodates the alarm smoke sensing chamber 4, the siren 5 and the 9 Volt Lithium ion battery 3A in battery compartment B and has a test button T, a ‘live’ indicator LED L and speaker grille for the siren on its front face.

The mounting pattress part 2b is saucer-shaped and has apertures in its base for passage of cabling as well as screw-holes for screwing to the ceiling and has a spaced pair of lugs that protrude (downwardly in use) from it to co-operatively engage with keyhole like sockets 8a, 8b in the main housing part 2a when the main housing part 2a is brought up into face-to-face mating position to the mounting pattress part 2b and the main housing part 2a rotated a few degrees relative to the screw-fixed mounting pattress part 2b.

The off-the-shelf ceiling mounted smoke sensor illustrated in FIGS. 3 and 6 is very conveniently and easily upgradable to the requirements of the present invention by provision of an intermediate housing plate 2c as shown in FIG. 4. This intermediate housing plate 2c is adapted to fit between the mounting pattress part 2b and the main housing part 2a. The intermediate housing plate 2c is approximately saucer-shaped and carries in it a PCB 15 and circuitry including the micro-controller 12 and the GSM module 13 with SIM card holder 14.

The intermediate housing plate 2c is effectively sandwiched between the mounting pattress part 2b and the main housing part 2a and the assembly can be secured using the existing co-operating lug and socket 8a, 8b arrangement of the smoke sensor assembly. For this purpose corresponding apertures/key-hole slots H are formed through the intermediate housing plate 2c, allowing the lugs to pass therethrough to reach the sockets 8a, 8b of the main housing part 2a.

Also very elegantly, the very same electrical coupling that is provided on the main housing part 2a for powering and linking the individual smoke sensor units together in a network is usable to electrically connect the circuitry of the intermediate housing plate 2c to the circuitry in the main housing part 2a. As illustrated, a pair of cables 11 have at one end a multi-pin plug 10 that push-fit couples into sockets containing respectively a ‘live’ pin 9a and an inter-connect pin 9b. At the other end the cables 11 pass up through a central aperture in the intermediate housing plate 2c and through a central aperture in the PCB 15 to be soldered into connection with connector pins of the circuit on the PCB 15.

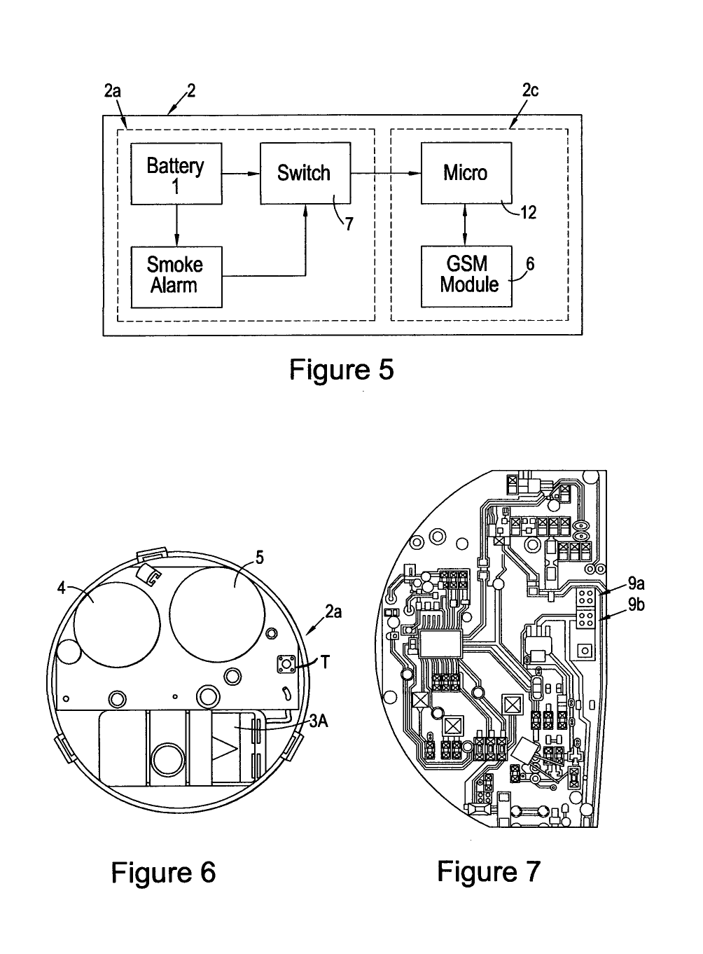

In contrast to the first embodiment, as shown in FIG. 5, the smoke alarm main housing part 2a contains the switch 7 that turns on the power to the telecommunications unit and the switch 7 turns on the power to the telecommunications unit only long enough to perform the task and is effectively an open-loop system.

Using the ingenious powering approach of the present invention the battery need not be changed frequently. Indeed battery change intervals of possibly up to 10,000 hours are not inconceivable. In standby/dormant mode the system may be arranged to draw not just low but infinitesimally low amounts of power such as for example 20 micro Amps. Such low power requirements may be achieved through use of a low power operational amplifier configured as a band pass filter. Such a filter would be arranged to only allow through tones consistent with a siren to trigger the system. Such a filter could be run straight from the battery to reduce any losses due to quiescent currents in a regulator circuit. The system may optionally be powered from a 9 Volt alkaline battery since its current drain is very low (zero power to the GSM unit) while dormant and very short-lived when active.

The system of the present invention may optionally be configured to be mains powered but with battery back-up and although benefitting less from the merits of the invention could still be very useful where mains power supply is unreliable. The term battery-powered used in the claims hereinafter includes within its scope systems that are battery-powered during power outages.

1. A battery-powered smoke/fire alarm unit which comprises a housing accommodating: at least a first battery; a smoke/fire detector with a TEST button and being linked to an audible alarm powered by the first battery; a telecommunications unit; and a switch responsive to triggering of the alarm to then connect the telecommunications unit to the first battery or to a second battery in the housing to thence power the telecommunications unit to send a warning message wherein the unit is adapted to be programmed by the user with phone numbers to be contacted by the unit by using the smoke/fire detector's TEST button to initiate programming.

2. A battery-powered smoke/fire alarm unit as claimed in claim 1, wherein the telecommunications unit is a GSM unit.

3. A battery-powered smoke/fire alarm unit as claimed in claim 1, wherein the telecommunications unit is configured to send an SMS text warning message warning of the detected smoke/fire via a mobile phone network to the mobile phone of a home-owner, tenant or other interested party.

4. A battery-powered smoke/fire alarm unit as claimed in claim 1, wherein the switch is electrically connected to the smoke/fire detector, to the audible alarm or to the connection between them so as to be directly or indirectly electrically triggered by the detection signal from the smoke/fire detector.

5. A battery-powered smoke/fire alarm unit as claimed in claim 1, wherein the switch comprises a microphone that is responsive to the sound of the audible smoke/fire alarm operating.

6. A battery-powered smoke/fire alarm unit as claimed in claim 1, wherein the smoke/fire alarm unit and the telecommunications unit are both powered solely by the first battery.

7. A battery-powered smoke/fire alarm unit as claimed in claim 6, wherein the battery is a Lithium ion battery.

8. A battery-powered alarm unit which comprises a housing accommodating: at least a first battery; a hazard (eg fire or flood) or intruder detector linked to an audible alarm powered by the first battery; a telecommunications unit; and a switch responsive to triggering of the alarm to then connect the telecommunications unit to the first battery or to a second battery in the housing to thence power the telecommunications unit to send a warning message, the switch comprising a microphone that is responsive to the sound of the audible alarm operating.

9. A battery-powered alarm unit as claimed in claim 8, wherein the switch connects the power to the telecommunications unit only long enough to successfully communicate the warning message.

10. A battery-powered alarm unit as claimed in claim 9, wherein the switch turns on the power to the telecommunications unit for a pre-set period of less than 5 seconds

11. A battery-powered alarm unit as claimed in claim 5, wherein the switch comprises a low power operational amplifier configured as a band pass filter and arranged to only allow through tones consistent with a siren to trigger the system.

12. A battery-powered alarm unit as claimed in claim 11, wherein the switch comprises a band pass filter run straight from the battery to reduce any losses due to quiescent currents in a regulator circuit.

13. A battery-powered alarm unit as claimed in claim 1, wherein the housing comprises a main alarm housing part, a mounting pattress and an intermediate housing plate adapted to fit between the mounting pattress part and the main alarm housing part.

14. A battery-powered alarm unit as claimed in claim 14, wherein the intermediate alarm housing plate is approximately saucer-shaped and carries in it a PCB and circuitry including a micro-controller and the telecommunications module.

15. A battery-powered alarm unit as claimed in claim 13, wherein the intermediate housing plate is sandwiched between the mounting pattress part and the main housing part and the assembly is secured using a co-operating mounting arrangement extending from the mounting pattress part through the intermediate housing plate to the main housing part or vice-versa.

16. A battery-powered alarm unit as claimed in claim 1 comprising a connecting cable between the alarm circuit and the telecommunications unit, the cable having a plug that push-fit couples into a socket containing a ‘live’/power pin and/or an inter-connect pin.

17-19. (canceled)

20. A battery-powered smoke/fire alarm unit as claimed in claim 1, wherein the TEST button of the smoke/fire detector when pressed powers up the telecommunications unit.

21. A battery-powered smoke/fire alarm unit as claimed in claim 20, wherein the TEST button of the smoke/fire detector when pressed makes an interlink pin of the unit live and thereby powers up the telecommunications unit.

22. A battery-powered smoke/fire alarm unit as claimed in claim 1, wherein the unit is configured so that once the telecommunications unit is powered up the user will be able to send a text message (from a phone that is to be used for receiving alert messages) to an allocated number of the telecommunication unit which will receive the message and store the number in its memory.

23. A battery-powered smoke/fire alarm unit as claimed in claim 1, wherein the unit is configured so that when, the test button is pressed for configuring the system the telecommunications unit will automatically send a warning message to all phone numbers stored in its memory (ie every time the telecommunications unit powers up it will transmit a message to the stored number(s).

24. A battery-powered smoke/fire alarm unit which comprises a housing accommodating: at least a first battery; a smoke/fire detector linked to an audible alarm powered by the first battery; a telecommunications unit; and a switch responsive to triggering of the alarm to then connect the telecommunications unit to the first battery or to a second battery in the housing to thence power the telecommunications unit to send a warning message wherein the smoke/fire detector is of a type that is adapted to be networked and the electrical coupling that is provided on the smoke/fire detector for powering and linking individual smoke/fire detectors together in a network is used to electrically connect the circuitry of the telecommunications unit thereto.

25. (canceled)

26. A battery-powered alarm unit as claimed in claim 8, wherein the switch comprises a low power operational amplifier configured as a band pass filter and arranged to only allow through tones consistent with a siren to trigger the system.

27. A battery-powered alarm unit as claimed in claim 26, wherein the switch comprises a band pass filter run straight from the battery to reduce any losses due to quiescent currents in a regulator circuit.

28. A battery-powered alarm unit as claimed in claim 8, wherein the intermediate housing plate is sandwiched between the mounting pattress part and the main housing part and the assembly is secured using a co-operating mounting arrangement extending from the mounting pattress part through the intermediate housing plate to the main housing part or vice-versa.

29. A battery-powered alarm unit as claimed in claim 8, comprising a connecting cable between the alarm circuit and the telecommunications unit, the cable having a plug that push-fit couples into a socket containing a ‘live’/power pin and/or an inter-connect pin.
